(19) United States
(12) Patent Application Publication
(10) Pub. No.: US 2023/0177431 A1
(43) Pub. Date: Jun. 8, 2023

(54) COLLABORATIVE SKILL MANAGEMENT

(71) Applicant: Macnica Americas, Inc., Solana Beach, CA (US)

(72) Inventors: Daichi Yoshikawa, Campbell, CA (US); Daisuke Nishimura, San Jose, CA (US)

(21) Appl. No.: 18/076,082

(22) Filed: Dec. 6, 2022

Related U.S. Application Data
(60) Provisional application No. 63/287,021, filed on Dec. 7, 2021.

(51) Int. Cl. G06Q 10/0631

(52) U.S. Cl. CPC G06Q 10/06316

(57) ABSTRACT

Collaborative skills management includes techniques for maintaining up-to-date skills data. Skill data for users is updated by both the users themselves as well as other users. Various rules can be applied depending on the application. Skill data can also be updated based on analysis of collaboration data.

### REFERENCE TO RELATED APPLICATIONS

This patent application claims the benefit of U.S. Provisional patent application Ser. No. 63/287,021 filed Dec. 7, 2021. This application incorporates by reference the above-identified Provisional patent application.

This patent application is related to and incorporates by reference the following U.S. patent applications and U.S. Provisional patent applications:
U.S. patent application Ser. No. 17/522,768 filed on Nov. 9, 2021, published as U.S. Pat. Pub. No. 2022/0147945 A1
U.S. patent application Ser. No. 17/522,784 filed on Nov. 9, 2021, published as U.S. Pat. Pub. No. 2022/0147903 A1
U.S. Prov. Ser. No. 63/111,547 filed Nov. 9, 2020;
U.S. Prov. Ser. No. 63/111,551 filed Nov. 9, 2020; and
U.S. Prov. Ser. No. 63/223,489 filed Jul. 19, 2021.

The above-referenced provisional and non-provisional patent applications are collectively referenced herein as “the commonly assigned incorporated applications.”

### FIELD

This patent specification generally relates to collaborative skill management. More particularly this specification relates to platforms for managing and using skill data obtaining from a population of individuals and to reducing network congestion, especially for intracompany networks, reducing computational power use of servers, and balancing transactions over a network over a longer period of time compared to known prior systems.

### BACKGROUND

Companies are increasingly facing a “digital skill gap” of employees. Some estimate that more than half of all employees will require significant reskilling in the near future. The gap is inevitable because many kinds of markets are driven and accelerated by digital technologies, and people who own some expertise in a specific domain need to catch up to new demands in the markets. To address the digital skill gap, companies are trying to more fully utilize existing resources, for example, by training/educating employees and/or re-assigning employees. Companies are also trying to address the digital skill gap by looking outside, for example, by finding and hiring new employees with required skill sets, or outsourcing from a third party.

### SUMMARY

According to some embodiments, a network-based collaborative skill management system configured to reduce computational load on user stations and on servers in the network and to reduce network load and network bandwidth requirements, comprises: a network; user stations, a communication facility, and a computer-implemented server facility, all interacting with and through the network, said server facility being configured to store skill sets for respective users; wherein said server facility is further configured to automatically update a respective skill set of a user based on interactions of other users with the user over said network and communication facility involving a skill that was not previously included in the skill set of the user; wherein said interactions include express requests by other users to add a skill to the skill set of the user based on interaction with the user involving the skill and a history of the user using the skill in interaction with other users over the network or through said communication facility; a filtering facility associated with the server and configured to limit the addition of skills to the skill set of the user based on one or more of acceptance of the addition by the user and the type and number of interactions of the user with other users involving the skill; and wherein the user stations are configured to display on request the skill set of a user as updated in said server facility, including as graphs each comprising nodes representing respective skills and edges representing relationships between skills.

According to some embodiments, the network-based collaborative skill management system can further include one or more of the following: the filtering facility cam be configured to limit the addition or a skill based on each of acceptance of the addition by the user and the type and number of interactions of the user with other users involving the skill, and the filtering facility can be configured to limit the addition or a skill based on the type and number of interactions of the user with other users involving the skill that meet a selected threshold of number and/or type of interaction.

According to some embodiments, a network-based collaborative skill management process configured to reduce computational load on user stations and on servers in the network and to reduce network load and network bandwidth requirements, comprises: establishing communications of users through user stations over a network and a communication facility with a computer-implemented server facility that is configured to store skill sets associated with respective users and to automatically update a respective skill set of a user based on interactions of other users with the user over said network and communication facility involving a skill that was not previously included in the skill set of the user; wherein said interactions include express requests by other users to add a skill to the skill set of the user based on interaction with the user involving the skill and a history of the user using the skill in interaction with other users over the network or through said communication facilities; filtering through said computer-implemented server facility the addition of skills to the skill set of the user based on one or more of acceptance of the addition by the user and the type and number of interactions of the user with other users involving the skill; and selectively displaying at the user stations the skill set of a user as updated in said server facility, including as graphs each comprising nodes representing respective skills and edges representing relationships between skills.

According to some embodiments, the network-based collaborative skill management process can further include one or more of the following: the filtering can be configured to limit the addition or a skill based on each of acceptance of the addition by the user and the type and number of interactions of the user with other users involving the skill, and the filtering can be configured to limit the addition or a skill based on the type and number of interactions of the user with other users involving the skill that meet a selected threshold of number and/or type of interaction.

According to some embodiments, a network-based collaborative skill management process configured to reduce computational load on user stations and on servers in the network and to reduce network load and network bandwidth requirements, comprises: establishing communications of users through user stations over a network and a communication facility with a computer-implemented server facility that is configured to store skill sets associated with respective users and to automatically update a respective skill set of a user based on interactions of other users with the user over said network and communication facility involving a skill that was not previously included in the skill set of the user; wherein said interactions include express requests by other users to add a skill to the skill set of the user based on interaction with the user involving the skill facilities; filtering through said computer-implemented server facility the addition of skills to the skill set of the user based on interactions of the user with other users involving the skill; and selectively displaying at the user stations the skill set of a user as updated in said server facility, including as graphs each comprising nodes representing respective skills and edges representing relationships between skills.

According to some embodiments, the network-based collaborative skill management process described in the immediately preceding paragraph can further include one or more of the following: the filtering can be further configured to filter the addition of a skill based on the number of interactions of the user that involve the skill, the filtering can be configured to limit the addition or a skill based on each of acceptance of the addition by the user and the type and number of interactions of the user with other users involving the skill, and the filtering can be configured to limit the addition or a skill based on the type and number of interactions of the user with other users involving the skill that meet a selected threshold of number and/or type of interaction.

As used herein, the grammatical conjunctions “and”, “or” and “and/or” are all intended to indicate that one or more of the cases, object or subjects they connect may occur or be present. In this way, as used herein the term “or” in all cases indicates an “inclusive or” meaning rather than an “exclusive or” meaning.

### BRIEF DESCRIPTION OF THE DRAWINGS

To further clarify the above and other advantages and features of the subject matter of this patent specification, specific examples of embodiments thereof are illustrated in the appended drawings. It should be appreciated that elements or components illustrated in one figure can be used in place of comparable or similar elements or components illustrated in another, and that these drawings depict only illustrative embodiments and are therefore not to be considered limiting of the scope of this patent specification or the appended claims. The subject matter hereof will be described and explained with additional specificity and detail through the use of the accompanying drawings in which:

FIGS. 1 and 2 show an example of graphical user interface input form to add skill data to other users, according to some embodiments;

FIGS. 3A and 3B show and example graphical user interface of a graph data structure, according to some embodiments; and

FIG. 4 is an example of graphical user interface of collaboration histories, according to some embodiments.

FIG. 5 is a schematic example of a networked system for collaborative skill management.

### DETAILED DESCRIPTION

A detailed description of examples of preferred embodiments is provided below. While several embodiments are described, it should be understood that the new subject matter described in this patent specification is not limited to any one embodiment or combination of embodiments described herein, but instead encompasses numerous alternatives, modifications, and equivalents. In addition, while numerous specific details are set forth in the following description in order to provide a thorough understanding, some embodiments can be practiced without some or all of these details. Moreover, for the purpose of clarity, certain technical material that is known in the related art has not been described in detail in order to avoid unnecessarily obscuring the new subject matter described herein. It should be clear that individual features of one or several of the specific embodiments described herein can be used in combination with features of other described embodiments or with other features. Further, like reference numbers and designations in the various drawings indicate like elements.

Notably, the detailed description below points out that the new approach to collaborative skill management is configured to improve computational efficiency of computers and servers, to reduce network loads especially for intracompany networks, to make more economical use of network bandwidth and to balance transactions over a greater length of time and bring about other benefits to the operation of computers, servers and networks.

As described in U.S. patent application Ser. No. 17/522,768, skills data for people, especially employees or members of a company, organization or group, etc. plays a significant role in addressing the issue of digital skills gap. While many collaboration tools and human resources software/services are known, a common drawback is a lack of a sustainable way to maintain users' profiles, especially skills data. Individuals may initialize their skills data when they start using a service, but many of them do not update data regularly. Due to the infrequent transactions of skills data update, the aforementioned software/services are only effective in a short term, or among a small subset of people, that is ones who update skills data regularly.

According to some embodiments, techniques are described to maintain skills data as up-to-date. The described techniques can be applied/embedded to platforms such as described in said U.S. patent application Ser. No. 17/522,784. The described techniques can also be applied to other services.

As used herein the term “skill” is interchangeable with “experience,” “familiarity” and/or “interest.” That is, the term “skill” is not limited to the ability to do something professionally. The term may include expertise, familiarity, and knowledge. According to some embodiments, described systems and techniques do not accept skills which the user only claims to possess, but are not also accompanied with some industrial and/or academic experiences.

As used herein the term “user” refers to a user of a service for managing skill data. The “service” may be a desktop application, SaaS, or PaaS, etc.

As used herein, the term “edit” refers to actions such as adding, deleting, coping, pasting, and/or modifying something.

When a skill and/or experience: (a) has a parent-child relationship with;

(b) is similar to; (c) is used for; or (d) is applied to other skill(s)/experience(s), it is said that the skill and/or experience has a “relevance” to other skill(s) and/or experience(s).

As used herein the terms “service” refers to a software service and includes a variety of software services. Examples include software services such as

SaaS, PaaS, desktop applications, and mobile applications.

As used herein, the term “company” can refer to an organization, school, university, college, governmental facility, institute and/or community.

As used herein, the term “employee” can refer to a student, officer, volunteer, or other person who belongs to a certain organization or company.

Functions for sustainable skills data. According to some embodiments, techniques are described for editing of skill data by other users. For example, since user A knows that user B has done a great job on AI technology for this project, user A can add “AI” to user B's skills data.

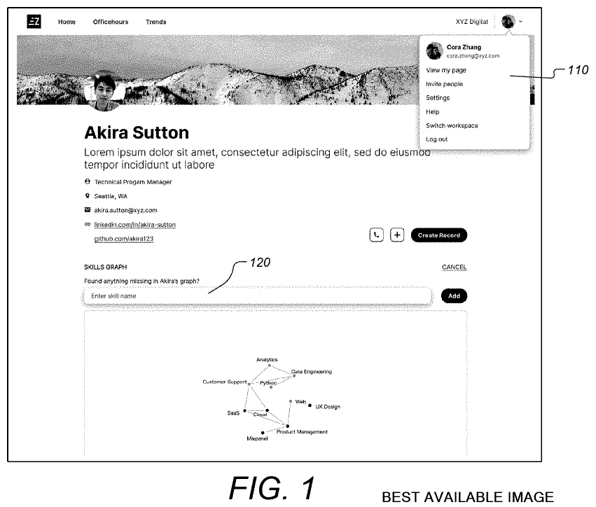

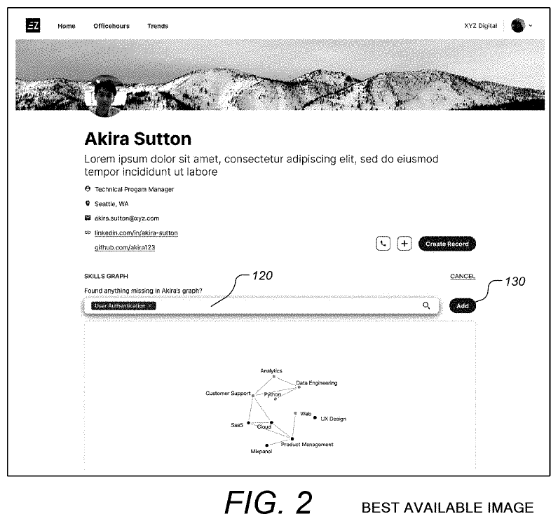

FIGS. 1 and 2 show an example of graphical user interface input form to add skill data to other users, according to some embodiments. In this example, a user logs in the service as “Cora Zhang.” The upper right pop up window 110 shows the logged in user information. In this case, the user Cora Zhang knows that Akira

Sutton is familiar with how to implement a function of “User Authentication” by Python. So she goes to Akira's user page, which is shown in FIG. 1, and sees an input form 120 to add skill to his record. The skill set shown in FIG. 1 can be in graphic form comprising notes designating respective skills and edges representing relationships between skills, as in said patent application Ser. No. 17/522,768. In FIG. 2, the user Cora Zhang inputs “User Authentication” in the form 120 and clicks the “Add” button 130.

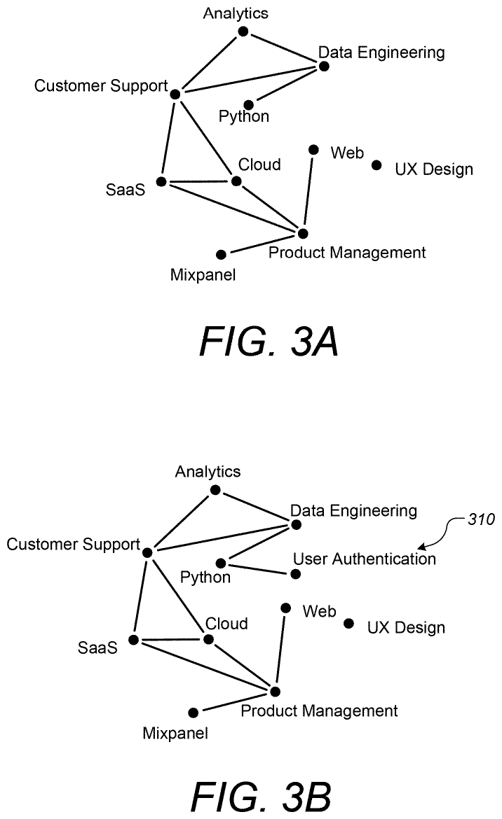

FIGS. 3A and 3B show an example graphical user interface of a graph data structure, according to some embodiments. The example shown is the same as discussed above with respect to FIGS. 1 and 2. The skills data is represented as a graph data structure. FIG. 3A shows the graph data structure for Akira Sutton prior to the function of “User Authentication” is added. The user Cora Zhang may connect added skill “User Authentication” and “Python” subsequently, since she knows Akira's expertise of “User Authentication” is related to “Python” language and vice versa. In FIG. 3B the graph data structure is shown with User Authentication 310 connected to Python.

According to some embodiments, the edit by other users technique may have one or more variations. According to some embodiments, the variations can be configured by someone who is assigned as an administrative level or other suitable level on the service. Following are examples of variations, of which any number may be implemented, depending upon the particular application and setting in which the service is being used: (1) Skill data may be edited by others without any constraints and permissions; (2) Only a subset of users may be allowed to edit other users' skill data. The subset may be configured by admin users; (3) Each user may configure permission for skills data edit by others; (4) Users may have an upper limit of the number of skill data which one user can add to others (e.g. the limit may be reset per some specific period (e.g. a week or month)); (5) Skills data may not be edited unless user A approves it; and (6) The edit may not be reflected until enough votes are collected by other different users (e.g., skill data of “AI” may not be added to user A until 3 other users vote on the addition; and the required number of votes may be customizable).

According to some embodiments, skill data added by others may be distinguishable from skill data added by oneself. Also, the relevant skills represented in the graph data structure may be edited by other users in addition to the skill data itself and skill edges may be added to the skill data graph.

Skills data management which relies on self-editing tends to become more rapidly obsolete because most users forget to maintain their own skills data regularly. As a result, systems relying on self-editing may also rely on one or more counter measurements. Many of these self-editing measurements are redundant and inefficient in terms of computational cost and management cost. Examples include: (1) a manager-class person or admin person, etc. may let/ask all users to update their own skills data regularly (e.g. every month, every quarter, etc.) regardless of necessity; (2) the service itself may regularly send notifications to all/some users to encourage them to edit their own skills data regardless of necessity.

Regular and/or redundant broadcasted notifications cause congestion of network infrastructure and consume computational costs of servers on which the service may also be running. Since these requests and notifications are often sent to many users in a very short period, network traffic (e.g., intracompany network traffic) may become extremely busy and users may be unable to access the service, and other services, during the period. According to some embodiments, the new techniques described herein for skill data co-editing tend to increases the frequency of updates of skills data and disperse the transactions over a longer period of time.

Accordingly, users will not require the same amount of the requests and notifications. In this way, many of the described embodiments will: (1) reduce network congestion; (2) use less computational power of servers, and (3) balance the transactions on the network over a greater length of time.

Following is another example scenario: (1) user A would like to suggest this skill to user B; (2) User A shares the suggestion with user B, through some message application such as email; (3) User B agrees with the suggestion and then adds the suggested skill on the system. In such a scenario, according to some embodiments described herein, the step (2) could be eliminated. Since transactions among users via messaging applications are reduced, network operation performance and efficiency is improved. Furthermore, computational power consumption is reduced through the implementation according to embodiments described herein.

Collaborative skills data management enables sustainable and efficient maintenance of skills data. According to some embodiments, users are incentivized to edit skills data more frequently. When applied to platforms such as described in the commonly assigned incorporated applications the techniques can be particularly effective. This is in part because some users have stronger incentive to add skill data to others. With such platforms, users who register a lot of skills data have a greater chance to be found by others (because users can search other users by skills) but may be bothered if they receive help requests too frequently. Instead of deleting registered skill data in an effort to reduce the number of help requests received, the user can instead share their workload with other experts by adding the equivalent skill data to other experts, whose skill data may not be well-maintained.

In addition, according to some embodiments, some problems associated with “cold starting” of such platforms can be alleviated. Platforms such as described in the commonly assigned incorporated applications may have functionalities such as a recommendation system that relies on skills data and/or skills data clustering. Since these functions rely on skills data associated with users, it takes time for users to fully use the functions. Many of the described embodiments can accelerate skills data accumulation due to more transactions of skills data updates.

According to some embodiments, skill data may be added based on collaboration data and its analyzed results. Sets for each corresponding service may be utilized to gather collaboration data. According to some embodiments, collaboration data can contain the following: (1) Chat/text data of collaboration tools, such as Slack, Microsoft Teams, etc. If user A asked a question about AI and user B answered it, then skill data of “AI” may be added to user B. Natural language processing may be used to analyze the relevant skill regarding the chat/text data. (2) Schedule data in user's calendar. For example, if user A has a schedule of meeting whose agenda is about this product X, skill data of “X” may be added to user A because it can be assumed that user A got to be familiar with it after the meeting(s). (3) Record of collaboration; if the service platform provides functionality which enables users to accumulate collaboration histories with some attributes such as experts name whom users collaborated with, hours saved thanks to expert's help/advice, spent hours, and topic of the collaboration. If user A created a collaboration record or that user B helped user A solve technical issues of AI software implementation, skill data of “AI” may be added to user B.

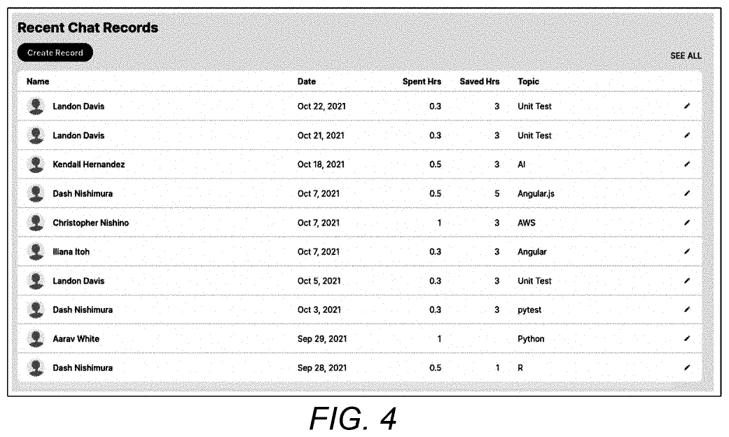

FIG. 4 is an example of graphical user interface of collaboration histories, according to some embodiments. In this case, skill data of “Unit Test” may be added to skill data of “Landon Davis” because Landon Davis helped him three times regarding Unit Test, and saved three hours for the user.

According to some embodiments, in any above cases, skill data may not be added immediately and may involve one or more of the following: (1) User B may approve/reject the addition; and (2) Skill data is not added until the number of the collaborations corresponding to the skill exceeds the configured threshold. For example, user B answered two questions regarding AI on System 1, and has three collaboration records regarding AI on System 2, so skill data of “AI” is added to user B, ifas far asif the threshold is 5.

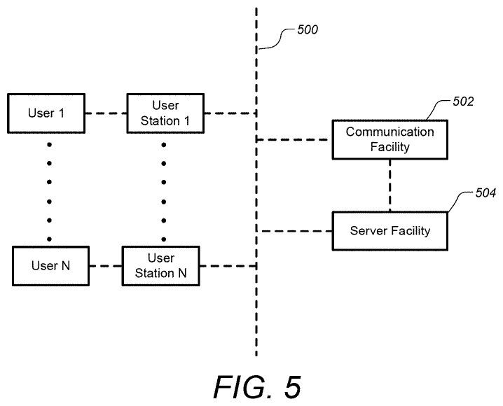

FIG. 5 shows in schematic form an example of a networked system for collaborative skill management according to the embodiments discussed above.

User stations 1 through N interact with a network 500, as do a communication facility 502 and a server facility 504. User stations 1-N can be personal computers or another type of computer-implemented devices. Communication facility 502 can be an email facility or a messaging facility or some other type of a facility through which users 1-N can communicate with each other or with server facility 504. The communications can be over network 500 or through another link. Server facility 504 can be one or more computer-implemented servers.

It should be noted that there are many alternative ways of implementing both the processes and apparatuses described herein. Accordingly, the present embodiments are to be considered as illustrative and not restrictive, and the body of work described herein is not to be limited to the details given herein, which may be modified within the scope and equivalents of the appended claims.

What it claimed is:

1. A network-based collaborative skill management system configured to reduce computational load on user stations and on servers in the network and to reduce network load and network bandwidth requirements, comprising:
a network;
user stations, a communication facility, and a computer-implemented server facility, all interacting with and through the network, said server facility being configured to store skill sets for respective users;
wherein said server facility is further configured to automatically update a respective skill set of a user based on interactions of other users with the user over said network and communication facility involving a skill that was not previously included in the skill set of the user;
wherein said interactions include express requests by other users to add a skill to the skill set of the user based on interaction with the user involving the skill and a history of the user using the skill in interaction with other users over the network or through said communication facility;
a filtering facility associated with the server and configured to limit the addition of skills to the skill set of the user based on one or more of acceptance of the addition by the user and the type and number of interactions of the user with other users involving the skill; and
wherein the user stations are configured to display on request the skill set of a user as updated in said server facility, including as graphs each comprising nodes representing respective skills and edges representing relationships between skills.

2. The network-based collaborative skill management system of claim 1, in which the filtering facility is configured to limit the addition or a skill based on each of acceptance of the addition by the user and the type and number of interactions of the user with other users involving the skill.

3. The network-based collaborative skill management system of claim 1, in which the filtering facility is configured to limit the addition or a skill based on the type and number of interactions of the user with other users involving the skill that meet a selected threshold of number and/or type of interaction.

4. A network-based collaborative skill management process configured to reduce computational load on user stations and on servers in the network and to reduce network load and network bandwidth requirements, comprising:
establishing communications of users through user stations over a network and a communication facility with a computer-implemented server facility that is configured to store skill sets associated with respective users and to automatically update a respective skill set of a user based on interactions of other users with the user over said network and communication facility involving a skill that was not previously included in the skill set of the user;
wherein said interactions include express requests by other users to add a skill to the skill set of the user based on interaction with the user involving the skill and a history of the user using the skill in interaction with other users over the network or through said communication facilities;
filtering through said computer-implemented server facility the addition of skills to the skill set of the user based on one or more of acceptance of the addition by the user and the type and number of interactions of the user with other users involving the skill; and
selectively displaying at the user stations the skill set of a user as updated in said server facility, including as graphs each comprising nodes representing respective skills and edges representing relationships between skills.

5. The network-based collaborative skill management process of claim 4, in which the filtering is configured to limit the addition or a skill based on each of acceptance of the addition by the user and the type and number of interactions of the user with other users involving the skill.

6. The network-based collaborative skill management process of claim 1, in which the filtering is configured to limit the addition or a skill based on the type and number of interactions of the user with other users involving the skill that meet a selected threshold of number and/or type of interaction.

7. A network-based collaborative skill management process configured to reduce computational load on user stations and on servers in the network and to reduce network load and network bandwidth requirements, comprising:
establishing communications of users through user stations over a network and a communication facility with a computer-implemented server facility that is configured to store skill sets associated with respective users and to automatically update a respective skill set of a user based on interactions of other users with the user over said network and communication facility involving a skill that was not previously included in the skill set of the user;
wherein said interactions include express requests by other users to add a skill to the skill set of the user based on interaction with the user involving the skill facilities;
filtering through said computer-implemented server facility the addition of skills to the skill set of the user based on interactions of the user with other users involving the skill; and
selectively displaying at the user stations the skill set of a user as updated in said server facility, including as graphs each comprising nodes representing respective skills and edges representing relationships between skills.

8. The network-based collaborative skill management process of claim 7, in which the filtering is further configured to filter the addition of a skill based on the number of interactions of the user that involve the skill.

9. The network-based collaborative skill management process of claim 7, in which the filtering is configured to limit the addition or a skill based on each of acceptance of the addition by the user and the type and number of interactions of the user with other users involving the skill.

10. The network-based collaborative skill management process of claim 7, in which the filtering is configured to limit the addition or a skill based on the type and number of interactions of the user with other users involving the skill that meet a selected threshold of number and/or type of interaction.
